(19) United States
(12) Patent Application Publication
(10) Pub. No.: US 2013/0098936 A1
(43) Pub. Date: Apr. 25, 2013

(54) REFRIGERATING CABINET FOR AUTOMATICALLY DISPENSING TENNIS BALLS

(71) Applicant: Gerard Kuma, Nice (FR)

(72) Inventor: Gerard Kuma, Nice (FR)

(73) Assignees: Cécile CERIANI, Nice (FR); Gérard KUMA, Nice (FR)

(21) Appl. No.: 13/642,735

(22) PCT Filed: Apr. 13, 2011
(86) PCT No.: PCT/FR2011/000216

§ 371 Date: Jan. 8, 2013

(30) Foreign Application Priority Data
Apr. 22, 2010 (FR) 10/01726

(51) Int. Cl. G07F 9/10

(52) U.S. Cl. CPC G07F 9/105
USPC 221/1; 221/150 R

(57) ABSTRACT

The invention relates to a refrigerating cabinet (1) for automatically dispensing sports balls. The invention is characterized in that said cabinet includes: a refrigeration system that keeps the sports balls at a temperature between +6° C. and +25° C.; a sports ball dispensing mechanism (4); and a sports ball container (5).

This invention relates to the field of balls for sports, and more particularly the field of the conservation and storage of balls for sports, in particular tubes of tennis balls.

Tennis balls are comprised of 53 grams of rubber and light felt that wither rather quickly. It is also the most renewed consumable items due to its rather brief lifespan. In France, about fifteen million balls are sold each year, which makes tennis the 5th most polluting sport (Sport et Vie Magazine—January 2007).

The game of the player is affected by a ball which is losing its elasticity and which has an erratic behavior. As such, the club competitor exhausts the quality of a tennis ball in two to four hours of play, while in international tournaments, each ball can be used only for nine games in accordance with the current legislation (seven to nine games on an ATP tour in forty-five minutes of play).

It results from the preceding that the type of balls sought by the player will depend on his level of play. It is therefore obvious that if the major competitors and professionals are indifferent to the parameters of longevity and cost price benefitting an exceptional quality; this is not the same for the regular player who requires from the ball a good level of performance along with a satisfactory longevity.

The occasional or debutant player is content rather with a low-end ball of which the drop in quality is necessarily compensated by a significant decrease in the sales price. Note that the balls in the tennis clubs are by far above all quality balls.

To date, tubes of tennis balls are substantially distributed via the mass distribution sports stores, stores specializing in sports equipment. Mail order and internet media internet remain alternatives that are still secondary as they are emerging. Within the tennis clubs, a more or less organized making available of tubes of balls sometimes allows the player to purchase new balls on site.

Tennis clubs substantially purchase their stock of pressurized balls in the mass distribution stores in the form of cartons of 18, 24 or 36 tubes or in the form of barrels of balls. The tubes are intended for the most part to meet the own needs of these clubs within the framework of tournaments and competitions that they organize all throughout the year, then for selling to their members.

The observation of the uses within clubs shows that none of the distribution networks is fully satisfactory, in particular for reasons of geographical proximity and management. Indeed, a service that is not guaranteed during the entire range of opening time of the courts, the availability of the personnel or benevolent persons according to the organizational diagram of clubs, the cash register problems or making change, combined with the difficulties inherent to the management of stocks makes making new tennis balls available to the players difficult.

Furthermore, another major problem which occurs in tennis clubs in particular, relates to the storage conditions of balls. It seems indeed that the storage of balls in inappropriate premises, i.e. which can be subjected to substantial temperature differences can alter the properties of tennis balls. So, it is therefore essential to ensure that the properties of the tennis balls remain constant and unchanged before they are used.

It does happen that tennis balls are, even before they are used, unusable in a game situation.

The modifications of the properties of the balls can be due to environmental factors such as in particular substantial differences in temperature, humidity and/or pressure. Likewise, the tubes of tennis balls, according to the materials that they are comprised of, can also be subjected to changes in form under certain conditions of pressure and/or temperature, making the product improper for sale.

It is known from document FR 2 620 548, the use in a tennis club, of an automatic dispensing cabinet, also called an automatic distributor, in monitored premises to deliver balls contained in their original tube by the intermediary of a change machine.

Automatic tennis ball tube distributor cabinets with high robustness are also known in document FR 2 604 277. These cabinets are, according to this document, well adapted to be arranged outdoors, as well as in an enclosed environment or on the tennis courts.

Finally, document FR 2 616 566 further discloses a device intended for the distribution of tubes containing tennis balls.

However, none of the distributor cabinets according to the documents hereinabove prevent the alteration of the tennis balls when said cabinets are subjected to substantial differences in temperature, humidity and/or pressure.

Therefore, an objective of this invention is to limit, before they are used, the alteration of tennis balls and of tubes of tennis balls and as such limit the wasting and the ecological damage that constitute the recycling of tennis balls that have not been used or tubes of tennis balls that have not been opened.

The invention therefore has for first object a refrigerating cabinet for automatically dispensing balls for sports comprising a refrigeration system that maintains the balls for sports at a temperature between +6° C. and +25° C., a sports ball dispensing mechanism, and a sports ball container.

Indeed, the Applicant has been able to demonstrate that tennis balls and tubes of tennis balls retain their original properties if their storage before distribution complies with particular temperature conditions. This is demonstrated by the detailed climate tests in examples 1 and 2 which show that at a temperature less than +6° C., the quality of the tennis balls makes them unusable in a game situation. Likewise, a temperature greater than +65° C. alters the quality of the tubes of tennis balls, making them improper for sale. As such, according to the invention, by remaining within this temperature interval between +6° C. and +65° C., the tennis balls as well as the tubes containing them are stored well and their properties are unaltered.

This solution goes against the bias according to which the storage of tennis balls, in particular pressurized tennis balls, can be improved solely by pressurizing said balls. It is indeed established that pressurized tennis balls contain a gas which escapes over time, with the ball therefore losing its pressure and becoming “soft”. In order to limit this escape process of the gas, in particular before opening, the balls are therefore pressurized, in such a way that the pressure in the tube is greater than the pressure in the ball. The property of a gas is to circulate from the high pressure zones to the low pressure zones. As such, the gas in the tennis ball therefore remains in said pressurized tennis ball before it is used. However, the incidence of the storage temperature on the quality of the tennis balls has, to date, never been taken into account during the storing of tennis balls before they are used.

The invention also has as a second object a method for storing and distributing balls for sports comprising the steps of:
filling an automatic dispensing cabinet with balls for sports;
storing said balls for sports at a temperature greater than or equal to +6° C., with the condition that the temperature does not exceed +60° C. when the balls for sports are contained in polyethylene terephtalate (PET) tubes; and of
dispensing balls for sports for payment of a corresponding sum.

The invention has for third object the use of a refrigerating cabinet for automatically dispensing balls for sports for the storing and dispensing of balls for sports, characterized in that the storage temperature is greater than or equal to +6° C., preferentially the storage temperature is between +8° C. and +15° C.

Finally, the invention has for fourth object a tube of tennis balls stored in a cabinet according to the invention.

Other purposes, advantages and characteristics of the invention shall be better understood when reading the following description and preferred embodiments, which are not restrictive, of the objet and of the scope of this patent application and which are drafted with regards to the annexed drawings, wherein:

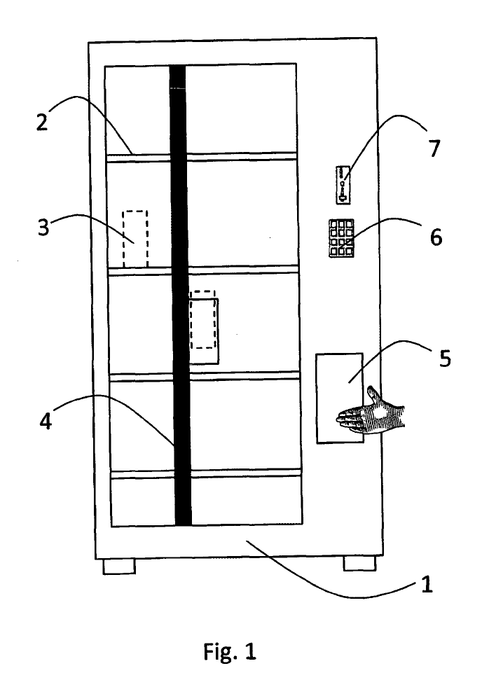

FIG. 1 diagrammatically shows a front view of an embodiment of the automatic dispensing cabinet according to the invention;

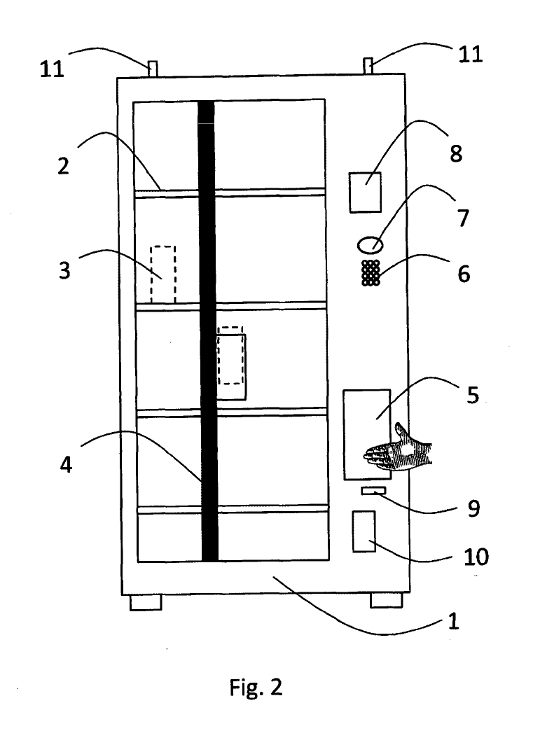

FIG. 2 diagrammatically shows a front view of a second embodiment of an automatic dispensing cabinet according to the invention;

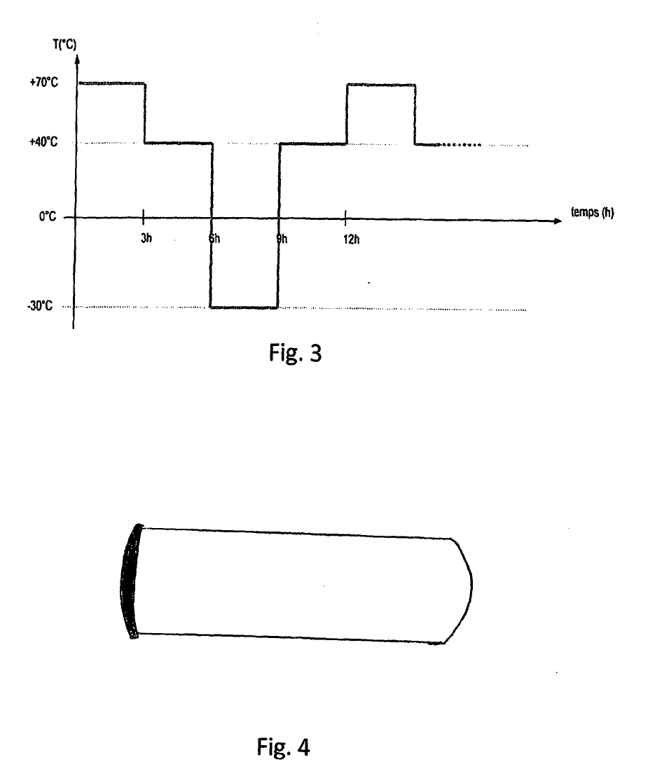

FIG. 3 shows a diagram of the cycle of temperatures to which the tubes of tennis balls are subjected to in example 1.

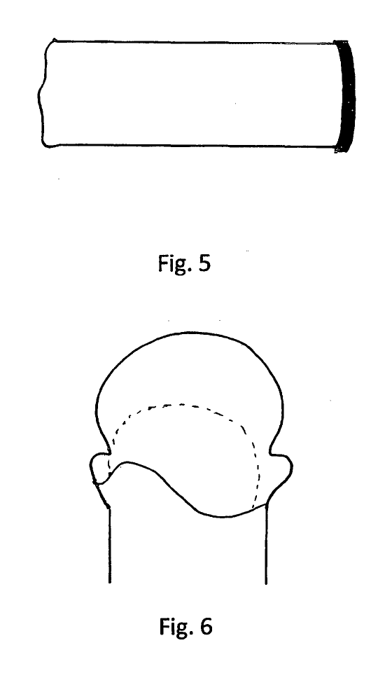

FIGS. 4 and 5 show front picture, reproduced by drawing, of tubes of tennis balls made from polyethylene terephtalate (PET) before the tests carried out in example 1; and

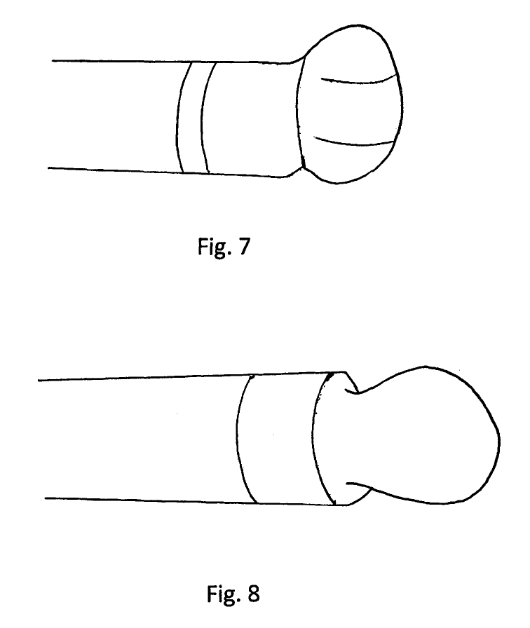

FIGS. 6, 7 and 8 show front picture, reproduced by drawing, of tubes of tennis balls made from polyethylene terephtalate (PET) after the tests carried out in example 1

FIGS. 1 and 2 show different possible alternatives of embodiments of automatic dispensing cabinets 1 according to the invention. As such, according to FIGS. 1 and 2, the balls for sports or the tubes comprising the balls for sports 3 are arranged on stages 2 and can be delivered on a container 5 for the product by a motorized elevator 4 in a X and Y plane. More preferably, the elevator is activated after insertion of the corresponding sum in a payment mean 7 and after composition of the code making it possible to deliver the chosen product on a selection keyboard 6.

According to a preferred embodiment of the invention, the balls for sports delivered by the automatic dispensing cabinet 1 are tennis balls. More preferably still, said tennis balls are contained in tubes, also called tennis ball cans.

Among the other distribution mechanisms that can be used for the cabinet 1 according to the invention, spirals, conveyor belts or revolving doors can be mentioned by way of non-restricted example. As shown in FIG. 1, in a preferred manner, the distribution mechanism of the dispensing cabinet according to the invention is a motorized elevator in a X and Y plane, more preferably encore, the elevator consists in a robotized arm system in a X and Y plane. This distribution mechanism has the advantage of gently delivering the products thanks to its robotized arm system.

The cabinet according to the invention can furthermore contain other refrigerated products chosen from among tennis accessories, beverages and/or food. By way of non-restricted examples of tennis accessories, racket overgrips, anti-vibration systems or tennis wristbands can be mentioned. By way of non-restricted examples of beverages, mineral waters, fruit juices or sodas can be mentioned, in formats such as 25 cl, 33 cl, 50 cl or 125 cl.

By way of non-restricted examples of food, products enriched with carbohydrates can be mentioned, in particular products adapted for athletes such as energy-providing mineral waters.

More preferably, the automatic dispensing cabinet according to the invention further comprises a payment mean. By way of non-restricted examples of payment mean, change machines, card readers, bank note acceptors or contactless payments can be mentioned in particular. Advantageously, the a payment mean is a change machine 7 such as shown in FIGS. 1 and 2.

By way of non-restricted example of a card reader, bank card readers and the electronic wallet can be mentioned such as in particular the Moneo® electronic wallet available in France.

The cabinet 1 according to the invention can contain more preferably between 10 and 100 rows of balls or tubes of balls, each row comprising between 4 and 30 balls or tubes of balls. More preferably still, the cabinet 1 comprises between 20 and 64 rows of balls or tubes of balls, each row comprising between 6 and 10 balls or tubes of balls.

Advantageously, the height of the cabinet 1 according to the invention is between 1200 and 2400 mm, more preferably between 1400 and 2000 mm, more preferably still, the height is 1830 mm.

The width of the cabinet 1 according to the invention is preferentially between 400 and 1600 mm, more preferably still between 750 and 990 mm.

The depth of the cabinet 1 according to the invention is preferentially between 400 and 1500 mm, more preferably still, the depth is approximately 870 to 880 mm.

The weight of the cabinet 1 according to the invention is preferentially between 200 and 1000 kg, more preferably still, the weight is approximately 400 kg.

Advantageously, the cabinet according to the invention can further contain:
a screen and/or a cut-out for payment system 8 such as shown in FIG. 2;
a coin returns 9 such as shown in FIG. 2;
a closing valve (10) such as shown in FIG. 2;
wall fastenings 11 such as shown in FIG. 2 making it possible to maintain fastened the cabinet 1.

According to the invention, the refrigeration system of the cabinet is an electronic or thermostat-controlled refrigeration system. More preferably, the refrigeration system is with electronic refrigeration and makes it possible to have a temperature between +6° C. and +25° C., more preferably between +8° C. and +14° C.

Of course, the invention is not limited to the embodiments described and shown in the attached figures and those skilled in the art can, using routine operations, realize other embodiments that are not described explicitly, without leaving the framework and the scope of this invention.

### EXAMPLE 1

### Climate Tests on the Tubes of Tennis Balls

The cabinet according to the invention must be able to dispense quality products. In particular, the tubes must not become unpressurized, regardless of the storage conditions.

As the cabinet according to the invention is intended for an international market, it is required that extreme climatic conditions be taken into consideration. In particular, the influence of the temperature on the behavior of the products must be studied. It was therefore required to set up climate tests on a batch of tubes of different brands, in order to obtain reliable information. In order to do this, climate tests on tubes of tennis balls containing tennis balls were carried out for one week in cycles of a duration of 12 h, with each cycle having four stages of three hours at temperatures of respectively +70° C., +40° C., −30° C., and +40° C., as shown in FIG. 3. Several types of products were tested in order to detect any differences in behavior:
“superior” quality balls packaged in tin tubes;
“superior” quality balls packaged in tubes made of polyethylene terephtalate (PET);
balls of average quality; and
low-end range balls, of Chinese manufacture.

The following models were placed in a climatic enclosure:
Wilson Championship® (tube of 3 balls)
Wilson Tour®
Teloon ITF approved®
Babolat Team®
Head ATP®

The comparison between the tubes of balls before the test, such as shown in FIGS. 4 and 5, with the tubes at the end of the test, such as shown in FIGS. 6 to 8 made it possible to detect a problem with tubes made of polyethylene terephtalate (PET). As shown in FIGS. 6 to 8, substantial deformation is observed on these tubes following the climate tests. These deformations seem to be due to the fact that the vitreous transition temperature (Tg) of the polyethylene terephtalate (PET) is 69° C. As such, the 70° C. stage changes the tubes made of polyethylene terephtalate (PET) to a rubbery state. Indeed, the pressure inside the tube causes an inflating as shown in FIGS. 6 to 8, at the hottest point, i.e. on the support stage, made of steel, whereon is placed the tube.

Besides the risk of depressurization if the tube is pierced, this deformation makes the product improper for sale. It is therefore imperative to not exceed the critical temperature of 70° C. for the preserving and storing of tubes of tennis balls, regardless of the outside conditions.

An inspection of the balls contained in the tubes that were subjected to the climate tests such as described hereinabove was carried out professional tennis players in a game situation. This method is more effective than a simple mechanical inspection of the tennis balls, since it makes it possible to note several aspects of the behavior of the balls, such as the bouncing, sensation, pressure and general quality. The results of these tests are reported in the table hereinbelow.

TABLE 1

| | | | | Score | | |
|---|---|---|---|---|---|---|
| | | | | out | | |
| | | | | of | | Climate |
| Brand | Pressure | Bounce | Sensation | 10 | Notes | test |
| Head | 7 | 8 | 8 | 8 | Good ball, | Yes |
| ATP | | | | | a little | |
| | | | | | light and | |
| | | | | | lively | |
| Wilson | 8 | 8 | 8 | 8.5 | Good ball, | Yes |
| Tour | | | | | very | |
| | | | | | lively and | |
| | | | | | consistent | |
| Dunlop | 3 | 4 | 4 | 4.5 | Very | No |
| fort | | | | | unpleasant, | |
| all | | | | | substantia | |
| court | | | | | l loss of | |
| | | | | | pressure | |
| Teloon | 9 | 7 | 6 | 6 | Average | Yes |
| ITF | | | | | ball | |
| approved | | | | | | |
| Teloon | 9 | 7 | 6 | 6 | Average | No |
| ITF | | | | | ball | |
| approved | | | | | | |
| Babolat | 8 | 8 | 8 | 8 | Good ball, | Yes |
| Team | | | | | quality of | |
| | | | | | the felt | |
| Babolat | 8 | 8 | 8 | 8.5 | Good ball, | No |
| Team | | | | | quality of | |
| | | | | | the felt, | |
| | | | | | lively | |
| Artengo | 5 | 6 | 6 | 6 | Average | No |
| | | | | | ball | |
| Wilson | 7 | 7 | 7 | 7.5 | Good ball, | Yes |
| Champion | | | | | less | |
| ship | | | | | lively | |
| | | | | | than the | |
| | | | | | Wilson | |
| | | | | | tour | |

In the table hereinabove, with regards to the pressure, a score of 10 corresponds to a hard ball, a score of 5 corresponds to an average ball and a score of 0 corresponds to a ball with low pressure. With regards to the bounce, a score of 10 corresponds to an excellent bounce, a score of 5 corresponds to an average bounce and a score of 0 corresponds to a very low bounce. With regards to the sensation, a score of 10 corresponds to an excellent sensation, a score of 5 corresponds to an average sensation, and a score of 0 corresponds to a very poor sensation. Finally, the score out of 10 represents the overall score attributed by the players to the ball.

The climate tests combined with the tests of the balls, described hereinabove made it possible to demonstrate that the balls contained in tubes subjected to extreme temperatures recover their original properties after a certain period of time, despite the fact that they cannot be used at a low temperature for example. However, tubes made from polyethylene terephtalate (PET) undergo deformations making them improper for sale.

### EXAMPLE 2

### Additional Climate Tests on Tennis Balls

In parallel to the tests carried out in example 1, other balls were placed in different enclosures cooled to temperatures of respectively +6° C., −5° C. and −18° C., in order to provide additional information.

The balls placed at +6° C., −5° C. and −18° C. made it possible to determine a minimum storage temperature. Indeed, at a temperature of +6° C., the tennis balls retain their essential qualities, while at −5° C. and at −18° C., they harden and become unusable.

The various tests carried out in examples 1 and 2 hereinabove made it possible to define the minimum and maximum storage temperatures, i.e. +6° C. for the minimum temperature for preserving the properties of the balls and +65° C. maximum in order to not damage the made from polyethylene terephtalate (PET).

1. A refrigerating cabinet for automatically dispensing balls for sports comprising:
a refrigeration system that maintains the balls for sports at a temperature between +6° C. and +25° C.;
a sports ball dispensing mechanism; and
a sports ball container.

2. The cabinet according to claim 1, wherein the balls for sports are tennis balls.

3. The cabinet according to claim 1, wherein the balls for sports are contained in tubes.

4. The cabinet according to claim 1, wherein the dispensing mechanism is a motorized elevator in a X and Y plane.

5. The cabinet according to claim 1, further comprising other products that can be refrigerated chosen from among tennis accessories, beverages and/or food.

6. A method for storing and distributing balls for sports comprising:
a. filling an automatic dispensing cabinet with balls for sports according to claim 1;
b. storing said balls for sports at a temperature between +6° C. and +25° C.; and
c. dispensing balls for sports for payment of a corresponding sum.

7. A method of storing and dispensing balls for sports, comprising storing balls for sports in a refrigerating cabinet for automatically dispensing balls for sports according to claim 1 at a storage temperature of between +6° C. and +25° C., and dispensing the balls from the refrigerating cabinet.

8. The method according to claim 7, wherein the storage temperature is between +8° C. et +15° C.

9. The method according to claim 7, wherein the balls for sports are tennis balls.

10. A tube of tennis balls stored in a refrigerating cabinet for automatically dispensing according to claim 1.

11. The cabinet according to claim 2, wherein the balls for sports are contained in tubes.

12. The cabinet according to claim 2, further comprising other products that can be refrigerated chosen from among tennis accessories, beverages and/or food.

13. The cabinet according to claim 3, further comprising other products that can be refrigerated chosen from among tennis accessories, beverages and/or food.

14. The cabinet according to claim 4, further comprising other products that can be refrigerated chosen from among tennis accessories, beverages and/or food.

15. The cabinet according to claim 11, further comprising other products that can be refrigerated chosen from among tennis accessories, beverages and/or food.

16. A method for storing and distributing balls for sports comprising:
a. filling an automatic dispensing cabinet with balls for sports according to claim 2;
b. storing said balls for sports at a temperature between +6° C. and +25° C.; and
c. dispensing balls for sports for payment of a corresponding sum.

17. A method for storing and distributing balls for sports comprising:
a. filling an automatic dispensing cabinet with balls for sports according to claim 3;
b. storing said balls for sports at a temperature between +6° C. and +25° C.; and
c. dispensing balls for sports for payment of a corresponding sum.

18. A method for storing and distributing balls for sports comprising:
a. filling an automatic dispensing cabinet with balls for sports according to claim 4;
b. storing said balls for sports at a temperature between +6° C. and +25° C.; and
c. dispensing balls for sports for payment of a corresponding sum.

19. A method for storing and distributing balls for sports comprising:
a. filling an automatic dispensing cabinet with balls for sports according to claim 5;
b. storing said balls for sports at a temperature between +6° C. and +25° C.; and
c. dispensing balls for sports for payment of a corresponding sum.

20. A method for storing and distributing balls for sports comprising:
a. filling an automatic dispensing cabinet with balls for sports according to claim 11;
b. storing said balls for sports at a temperature between +6° C. and +25° C.; and
c. dispensing balls for sports for payment of a corresponding sum.
